(19) United States
(12) Patent Application Publication
(10) Pub. No.: US 2024/0414120 A1
(43) Pub. Date: Dec. 12, 2024

(54) METHOD, APPARATUS, AND COMPUTER PROGRAM

(71) Applicant: Nokia Technologies Oy, Espoo (FI)

(72) Inventors: Klaus HOFFMANN, Munich (DE); Shubhranshu SINGH, Munich (DE)

(21) Appl. No.: 18/699,425

(22) PCT Filed: Oct. 8, 2021
(86) PCT No.: PCT/IB2021/059252

§ 371 Date: Apr. 8, 2024

(51) Int. Cl. H04L 61/4541; H04L 61/5014

(52) U.S. Cl. CPC H04L 61/4541; H04L 61/5014

(57) ABSTRACT

An apparatus comprises means configured to: receive a request from a communications device requesting one or more internet protocol addresses via a dynamic host configuration protocol; during establishment of a packet data unit session for the communications device, invoking a dynamic host configuration protocol server function to provide the requested one or more internet protocol addresses; and allocating an edge application server discovery function.

### FIELD

The present application relates to a method, apparatus, and computer program and in particular but not exclusively a method, apparatus, and computer program relating to use of a dynamic host configuration protocol for session management in edge computing applications.

### BACKGROUND

A communication system can be seen as a facility that enables communication sessions between two or more entities such as communication devices, base stations and/or other nodes by providing carriers between the various entities involved in the communications path.

The communication system may be a wireless communication system. Examples of wireless systems comprise public land mobile networks (PLMN) operating based on radio standards such as those provided by 3GPP, satellite based communication systems and different wireless local networks, for example wireless local area networks (WLAN). The wireless systems can typically be divided into cells, and are therefore often referred to as cellular systems.

The communication system and associated devices typically operate in accordance with a given standard or specification which sets out what the various entities associated with the system are permitted to do and how that should be achieved. Communication protocols and/or parameters which may be used for the connection are also typically defined.

### SUMMARY

According to an aspect, there is provided an apparatus comprising means configured to: receive a request from a communications device requesting one or more internet protocol addresses via a dynamic host configuration protocol; during establishment of a packet data unit session for the communications device, invoke a dynamic host configuration protocol server function to provide the requested one or more internet protocol addresses; and allocate an edge application server discovery function.

The dynamic host configuration protocol server function may be provided by a session management function or by a dynamic host configuration protocol server in a same network as the session management function.

The means may be configured to provide, the one or more requested internet protocol addresses to the edge application server discovery function allocated to the communications device.

The means may be configured to during the edge application server discovery function session context update, provide the communications device with one or more of the one or more requested internet protocol addresses and an internet protocol address of the edge application server discovery function.

The request from the communications device for the internet protocol address via dynamic host configuration protocol may be provided in a protocol configuration option.

The means may be configured to inspect a dynamic host configuration protocol response message to replace one of a domain name server internet protocol address and an internet protocol address of the edge application server discovery function with the other of the domain name server internet protocol address and the internet protocol address of the edge application server discovery and cause the modified message to be provided to the communications device.

The dynamic host configuration protocol response message may comprise one of a dynamic host configuration protocol ACK message and a relay reply message.

The means may be configured to configure the edge application server discovery function with one or more of the communications device internet protocol address and one or more internet protocol addresses associated with respective domain name server servers to which domain name server traffic not matching one or more criteria associated with the edge application server discovery function is to be forwarded.

The internet protocol address may comprise one or more of an internet protocol address for the user equipment; one or more internet protocol addresses of a domain name server; a server internet protocol address, a proxy-call session control function internet protocol address; and a layer 2 tunnelling protocol network server internet protocol address.

The means may be configured to determine a change relating to the edge application server discovery function.

The change may comprise: a change of edge application server discovery function; a change of the edge application server discovery function from available to unavailable; and a change of the edge application server discovery function from unavailable to available; a change of a function from available to unavailable within the edge application server discovery function; a change of a function from unavailable to available within the edge application server discovery function.

The means may be configured to, in response to determining a change relating to the edge application server discovery function cause an updated dynamic host configuration protocol procedure to be performed.

The means may be configured to cause a message to be sent to the communications device to cause the updated dynamic host configuration protocol procedure to be performed.

The causing the message to be sent to the communications device to cause the updated dynamic host configuration protocol procedure to be performed may comprise sending a message to a user plane function which causes the message to be sent to the communications device to cause the updated dynamic host configuration protocol procedure to be performed

The message to the communications device to cause the updated dynamic host configuration protocol procedure to be performed may comprise a dynamic host configuration protocol force renew message or a dynamic host configuration protocol reconfigure message.

The causing the message to be sent to the communications device to cause the updated dynamic host configuration protocol procedure to be performed may comprise sending a session management function session modification message with a protocol configuration option carrying an indication to trigger the updated dynamic host configuration protocol procedure to be performed.

The means may be configured to determine, based on advertisement by the communications device in packet data unit session establishment that the updated dynamic host configuration protocol procedure for communications device is triggered by one or more of a protocol configuration option and the dynamic host configuration protocol message.

The apparatus may be provided by or in a session management function.

According to another aspect, there is provided an apparatus, the apparatus comprising at least one processor and at least one memory including a computer program code, the at least one memory and computer program code configured to, with the at least one processor, cause the apparatus at least to: receive a request from a communications device requesting one or more internet protocol addresses via a dynamic host configuration protocol; during establishment of a packet data unit session for the communications device, invoke a dynamic host configuration protocol server function to provide the requested one or more internet protocol addresses; and allocate an edge application server discovery function.

The dynamic host configuration protocol server function may be provided by a session management function or by a dynamic host configuration protocol server in a same network as the session management function.

The at least one memory and at least one processor may be configured to cause the apparatus to provide, the one or more requested internet protocol addresses to the edge application server discovery function allocated to the communications device.

The at least one memory and at least one processor may be configured to cause the apparatus to, during the edge application server discovery function session context update, provide the communications device with one or more of the one or more requested internet protocol addresses and an internet protocol address of the edge application server discovery function.

The request from the communications device for the internet protocol address via dynamic host configuration protocol may be provided in a protocol configuration option.

The at least one memory and at least one processor may be configured to cause the apparatus to inspect a dynamic host configuration protocol response message to replace one of a domain name server internet protocol address and an internet protocol address of the edge application server discovery function with the other of the domain name server internet protocol address and the internet protocol address of the edge application server discovery and cause the modified message to be provided to the communications device.

The dynamic host configuration protocol response message may comprise one of a dynamic host configuration protocol ACK message and a relay reply message.

The at least one memory and at least one processor may be configured to cause the apparatus to configure the edge application server discovery function with one or more of the communications device internet protocol address and one or more internet protocol addresses associated with respective domain name server servers to which domain name server traffic not matching one or more criteria associated with the edge application server discovery function is to be forwarded.

The internet protocol address may comprise one or more of an internet protocol address for the user equipment; one or more internet protocol addresses of a domain name server; a server internet protocol address, a proxy-call session control function internet protocol address; and a layer 2 tunnelling protocol network server internet protocol address.

The at least one memory and at least one processor may be configured to cause the apparatus to determine a change relating to the edge application server discovery function.

The change may comprise: a change of edge application server discovery function; a change of the edge application server discovery function from available to unavailable; and a change of the edge application server discovery function from unavailable to available; a change of a function from available to unavailable within the edge application server discovery function; a change of a function from unavailable to available within the edge application server discovery function.

The at least one memory and at least one processor may be configured to cause the apparatus to, in response to determining a change relating to the edge application server discovery function cause an updated dynamic host configuration protocol procedure to be performed.

The at least one memory and at least one processor may be configured to cause the apparatus to cause a message to be sent to the communications device to cause the updated dynamic host configuration protocol procedure to be performed.

The causing the message to be sent to the communications device to cause the updated dynamic host configuration protocol procedure to be performed may comprise sending a message to a user plane function which causes the message to be sent to the communications device to cause the updated dynamic host configuration protocol procedure to be performed

The message to the communications device to cause the updated dynamic host configuration protocol procedure to be performed may comprise a dynamic host configuration protocol force renew message or a dynamic host configuration protocol reconfigure message.

The causing the message to be sent to the communications device to cause the updated dynamic host configuration protocol procedure to be performed may comprise sending a session management function session modification message with a protocol configuration option carrying an indication to trigger the updated dynamic host configuration protocol procedure to be performed.

The at least one memory and at least one processor may be configured to cause the apparatus to determine, based on advertisement by the communications device in packet data unit session establishment that the updated dynamic host configuration protocol procedure for communications device is triggered by one or more of a protocol configuration option and the dynamic host configuration protocol message.

The apparatus may be provided by or in a session management function.

According to another aspect, there is provided a method comprising: receiving at a session management function a request from a communications device requesting one or more internet protocol addresses via a dynamic host configuration protocol; during establishment of a packet data unit session for the communications device, invoking a dynamic host configuration protocol server function by the session management function to provide the requested one or more internet protocol addresses; and allocating by the session management function an edge application server discovery function.

The dynamic host configuration protocol server function may be provided by the session management function or by a dynamic host configuration protocol server in a same network as the session management function.

The method may comprise providing by the session management function, the one or more requested internet protocol addresses to the edge application server discovery function allocated to the communications device.

The method may comprise during the edge application server discovery function session context update, providing the communications device with one or more of the one or more requested internet protocol addresses and an internet protocol address of the edge application server discovery function.

The request from the communications device for the internet protocol address via dynamic host configuration protocol may be provided in a protocol configuration option.

The method may comprise inspecting a dynamic host configuration protocol response message to replace one of a domain name server internet protocol address and an internet protocol address of the edge application server discovery function with the other of the domain name server internet protocol address and the internet protocol address of the edge application server discovery and causing the modified message to be provided to the communications device.

The dynamic host configuration protocol response message may comprise one of a dynamic host configuration protocol ACK message and a relay reply message.

The method may comprise configuring by the session management function the edge application server discovery function with one or more of the communications device internet protocol address and one or more internet protocol addresses associated with respective domain name server servers to which domain name server traffic not matching one or more criteria associated with the edge application server discovery function is to be forwarded.

The internet protocol address may comprise one or more of an internet protocol address for the user equipment; one or more internet protocol addresses of a domain name server; a server internet protocol address, a proxy-call session control function internet protocol address; and a layer 2 tunnelling protocol network server internet protocol address.

The method may comprise determining a change relating to the edge application server discovery function.

The change may comprise: a change of edge application server discovery function; a change of the edge application server discovery function from available to unavailable; and a change of the edge application server discovery function from unavailable to available; a change of a function from available to unavailable within the edge application server discovery function; a change of a function from unavailable to available within the edge application server discovery function.

The method may comprise, in response to determining a change relating to the edge application server discovery function causing an updated dynamic host configuration protocol procedure to be performed.

The method may comprise causing by the session management function a message to be sent to the communications device to cause the updated dynamic host configuration protocol procedure to be performed.

The causing by the session management function the message to be sent to the communications device to cause the updated dynamic host configuration protocol procedure to be performed may comprise sending a message to a user plane function which causes the message to be sent to the communications device to cause the updated dynamic host configuration protocol procedure to be performed

The message to the communications device to cause the updated dynamic host configuration protocol procedure to be performed may comprise a dynamic host configuration protocol force renew message or a dynamic host configuration protocol reconfigure message.

The method may comprise causing by the session management function the message to be sent to the communications device to cause the updated dynamic host configuration protocol procedure to be performed may comprise sending a session management function session modification message with a protocol configuration option carrying an indication to trigger the updated dynamic host configuration protocol procedure to be performed.

The method may comprise determining by the session management function, based on advertisement by the communications device in packet data unit session establishment that the updated dynamic host configuration protocol procedure for communications device is triggered by one or more of a protocol configuration option and the dynamic host configuration protocol message.

The method may be performed by an apparatus. The apparatus by be provided by or in a session management function.

According to another aspect, there is provided an apparatus comprising means configured to: receive a request from a communications device requesting an internet protocol address via a dynamic host configuration protocol; invoke a dynamic host configuration protocol relay function to provide the one or more requested internet protocol addresses; and allocate an edge application server discovery function for the communications device.

The means may be configured to send by dynamic host configuration protocol relay function a request to a dynamic host configuration protocol external to a network of the session management function.

The allocating of the edge application server discovery function for the communications device may be performed after the one or more requested internet protocol addresses has been provided.

The allocating of the edge application server discovery function for the communications device may performed without the one or more requested internet protocol addresses and after the one or more requested internet protocol addresses is available, the means may be configured to provide the one or more requested internet protocol addresses to the edge application server discovery function.

The means may be configured to initially provide an identifier instead of the one or more requested internet protocol addresses and subsequently provide the one or more requested internet protocol addresses.

The means may be configured to provide, the one or more requested internet protocol addresses to the edge application server discovery function allocated to the communications device.

The means may be configured to during the edge application server discovery function session context update, provide the communications device with one or more of the one or more requested internet protocol addresses and an internet protocol address of the edge application server discovery function.

The request from the communications device for the internet protocol address via dynamic host configuration protocol may be provided in a protocol configuration option.

The means may be configured to inspect a dynamic host configuration protocol response message to replace one of a domain name server internet protocol address and an internet protocol address of the edge application server discovery function with the other of the domain name server internet protocol address and the internet protocol address of the edge application server discovery and cause the modified message to be provided to the communications device.

The dynamic host configuration protocol response message may comprise one of a dynamic host configuration protocol ACK message and a relay reply message.

The means may be configured to configure the edge application server discovery function with one or more of the communications device internet protocol address and one or more internet protocol addresses associated with respective domain name server servers to which domain name server traffic not matching one or more criteria associated with the edge application server discovery function is to be forwarded.

The internet protocol address may comprise one or more of an internet protocol address for the user equipment; one or more internet protocol addresses of a domain name server; a server internet protocol address, a proxy-call session control function internet protocol address; and a layer 2 tunnelling protocol network server internet protocol address.

The means may be configured to determine a change relating to the edge application server discovery function.

The change may comprise: a change of edge application server discovery function; a change of the edge application server discovery function from available to unavailable; and a change of the edge application server discovery function from unavailable to available; a change of a function from available to unavailable within the edge application server discovery function; a change of a function from unavailable to available within the edge application server discovery function.

The means may be configured to, in response to determining a change relating to the edge application server discovery function cause an updated dynamic host configuration protocol procedure to be performed.

The means may be configured to cause a message to be sent to the communications device to cause the updated dynamic host configuration protocol procedure to be performed.

The causing the message to be sent to the communications device to cause the updated dynamic host configuration protocol procedure to be performed may comprise sending a message to a user plane function which causes the message to be sent to the communications device to cause the updated dynamic host configuration protocol procedure to be performed

The message to the communications device to cause the updated dynamic host configuration protocol procedure to be performed may comprise a dynamic host configuration protocol force renew message or a dynamic host configuration protocol reconfigure message.

The causing the message to be sent to the communications device to cause the updated dynamic host configuration protocol procedure to be performed may comprise sending a session management function session modification message with a protocol configuration option carrying an indication to trigger the updated dynamic host configuration protocol procedure to be performed.

The means may be configured to determine, based on advertisement by the communications device in packet data unit session establishment that the updated dynamic host configuration protocol procedure for communications device is triggered by one or more of a protocol configuration option and the dynamic host configuration protocol message.

The apparatus by be provided by or in a session management function.

According to another aspect, there is provided an apparatus, the apparatus comprising at least one processor and at least one memory including a computer program code, the at least one memory and computer program code configured to, with the at least one processor, cause the apparatus at least to: receive a request from a communications device requesting an internet protocol address via a dynamic host configuration protocol; invoke a dynamic host configuration protocol relay function to provide the one or more requested internet protocol addresses; and allocate an edge application server discovery function for the communications device.

The at least one memory and at least one processor may be configured to cause the apparatus to send by the dynamic host configuration protocol relay function a request to a dynamic host configuration protocol external to a network of the session management function.

The allocating of the edge application server discovery function for the communications device may be performed after the one or more requested internet protocol addresses has been provided.

The allocating of the edge application server discovery function for the communications device may performed without the one or more requested internet protocol addresses and after the one or more requested internet protocol addresses is available, the at least one memory and at least one processor may be configured to cause the apparatus to provide the one or more requested internet protocol addresses to the edge application server discovery function.

The at least one memory and at least one processor may be configured to cause the apparatus to initially provide an identifier instead of the one or more requested internet protocol addresses and subsequently providing by the session management function the one or more requested internet protocol addresses.

The at least one memory and at least one processor may be configured to cause the apparatus to provide, the one or more requested internet protocol addresses to the edge application server discovery function allocated to the communications device.

The at least one memory and at least one processor may be configured to cause the apparatus to, during the edge application server discovery function session context update, provide the communications device with one or more of the one or more requested internet protocol addresses and an internet protocol address of the edge application server discovery function.

The request from the communications device for the internet protocol address via dynamic host configuration protocol may be provided in a protocol configuration option.

The at least one memory and at least one processor may be configured to cause the apparatus to inspect a dynamic host configuration protocol response message to replace one of a domain name server internet protocol address and an internet protocol address of the edge application server discovery function with the other of the domain name server internet protocol address and the internet protocol address of the edge application server discovery and cause the modified message to be provided to the communications device.

The dynamic host configuration protocol response message may comprise one of a dynamic host configuration protocol ACK message and a relay reply message.

The at least one memory and at least one processor may be configured to cause the apparatus to configure the edge application server discovery function with one or more of the communications device internet protocol address and one or more internet protocol addresses associated with respective domain name server servers to which domain name server traffic not matching one or more criteria associated with the edge application server discovery function is to be forwarded.

The internet protocol address may comprise one or more of an internet protocol address for the user equipment; one or more internet protocol addresses of a domain name server; a server internet protocol address, a proxy-call session control function internet protocol address; and a layer 2 tunnelling protocol network server internet protocol address.

The at least one memory and at least one processor may be configured to cause the apparatus to determine a change relating to the edge application server discovery function.

The change may comprise: a change of edge application server discovery function; a change of the edge application server discovery function from available to unavailable; and a change of the edge application server discovery function from unavailable to available; a change of a function from available to unavailable within the edge application server discovery function; a change of a function from unavailable to available within the edge application server discovery function.

The at least one memory and at least one processor may be configured to cause the apparatus to, in response to determining a change relating to the edge application server discovery function cause an updated dynamic host configuration protocol procedure to be performed.

The at least one memory and at least one processor may be configured to cause the apparatus to cause a message to be sent to the communications device to cause the updated dynamic host configuration protocol procedure to be performed.

The causing the message to be sent to the communications device to cause the updated dynamic host configuration protocol procedure to be performed may comprise sending a message to a user plane function which causes the message to be sent to the communications device to cause the updated dynamic host configuration protocol procedure to be performed

The message to the communications device to cause the updated dynamic host configuration protocol procedure to be performed may comprise a dynamic host configuration protocol force renew message or a dynamic host configuration protocol reconfigure message.

The causing the message to be sent to the communications device to cause the updated dynamic host configuration protocol procedure to be performed may comprise sending a session management function session modification message with a protocol configuration option carrying an indication to trigger the updated dynamic host configuration protocol procedure to be performed.

The at least one memory and at least one processor may be configured to cause the apparatus to determine, based on advertisement by the communications device in packet data unit session establishment that the updated dynamic host configuration protocol procedure for communications device is triggered by one or more of a protocol configuration option and the dynamic host configuration protocol message.

The apparatus by be provided by or in a session management function.

According to another aspect, there is provided a method comprising: receiving at a session management function a request from a communications device requesting an internet protocol address via a dynamic host configuration protocol; invoking a dynamic host configuration protocol relay function by the session management function to provide the one or more requested internet protocol addresses; and allocating by the session management function an edge application server discovery function for the communications device.

The method may comprise sending by dynamic host configuration protocol relay function a request to a dynamic host configuration protocol external to a network of the session management function.

The allocating of the edge application server discovery function for the communications device may be performed after the one or more requested internet protocol addresses has been provided.

The allocating of the edge application server discovery function for the communications device may performed without the one or more requested internet protocol addresses and after the one or more requested internet protocol addresses is available, the method may comprise providing the one or more requested internet protocol addresses to the edge application server discovery function.

The method may comprise initially providing by the session management function an identifier instead of the one or more requested internet protocol addresses and subsequently providing by the session management function the one or more requested internet protocol addresses.

The method may comprise providing by the session management function, the one or more requested internet protocol addresses to the edge application server discovery function allocated to the communications device.

The method may comprise during the edge application server discovery function session context update, providing the communications device with one or more of the one or more requested internet protocol addresses and an internet protocol address of the edge application server discovery function.

The request from the communications device for the internet protocol address via dynamic host configuration protocol may be provided in a protocol configuration option.

The method may comprise inspecting a dynamic host configuration protocol response message to replace one of a domain name server internet protocol address and an internet protocol address of the edge application server discovery function with the other of the domain name server internet protocol address and the internet protocol address of the edge application server discovery and causing the modified message to be provided to the communications device.

The dynamic host configuration protocol response message may comprise one of a dynamic host configuration protocol ACK message and a relay reply message.

The method may comprise configuring by the session management function the edge application server discovery function with one or more of the communications device internet protocol address and one or more internet protocol addresses associated with respective domain name server servers to which domain name server traffic not matching one or more criteria associated with the edge application server discovery function is to be forwarded.

The internet protocol address may comprise one or more of an internet protocol address for the user equipment; one or more internet protocol addresses of a domain name server; a server internet protocol address, a proxy-call session control function internet protocol address; and a layer 2 tunnelling protocol network server internet protocol address.

The method may comprise determining a change relating to the edge application server discovery function.

The change may comprise: a change of edge application server discovery function; a change of the edge application server discovery function from available to unavailable; and a change of the edge application server discovery function from unavailable to available; a change of a function from available to unavailable within the edge application server discovery function; a change of a function from unavailable to available within the edge application server discovery function.

The method may comprise, in response to determining a change relating to the edge application server discovery function causing an updated dynamic host configuration protocol procedure to be performed.

The method may comprise causing by the session management function a message to be sent to the communications device to cause the updated dynamic host configuration protocol procedure to be performed.

The causing by the session management function the message to be sent to the communications device to cause the updated dynamic host configuration protocol procedure to be performed may comprise sending a message to a user plane function which causes the message to be sent to the communications device to cause the updated dynamic host configuration protocol procedure to be performed

The message to the communications device to cause the updated dynamic host configuration protocol procedure to be performed may comprise a dynamic host configuration protocol force renew message or a dynamic host configuration protocol reconfigure message.

The method may comprise causing by the session management function the message to be sent to the communications device to cause the updated dynamic host configuration protocol procedure to be performed may comprise sending a session management function session modification message with a protocol configuration option carrying an indication to trigger the updated dynamic host configuration protocol procedure to be performed.

The method may comprise determining by the session management function, based on advertisement by the communications device in packet data unit session establishment that the updated dynamic host configuration protocol procedure for communications device is triggered by one or more of a protocol configuration option and the dynamic host configuration protocol message.

The method may be performed by an apparatus. The apparatus by be provided by or in a session management function.

According to another aspect, there is provided an apparatus comprising means configured to: cause a request to be provided to a session management function requesting one or more an internet protocol addresses via a dynamic host configuration protocol; receive during establishment of a packet data unit session for a communications device, the one or more requested internet protocol addresses; and receive an internet protocol address of an edge application server discovery function allocated to the communications device.

The request may be provided in a protocol configuration option.

The means may be configured to receive a modified message wherein a dynamic host configuration protocol response message is modified to replace one of a domain name server internet protocol address and an internet protocol address of the edge application server discovery function with the other of the domain name server internet protocol address and the internet protocol address of the edge application server discovery to provide said modified message.

The dynamic host configuration protocol response message may comprise one of a dynamic host configuration protocol ACK message and a relay reply message.

The means may be configured to receive a message to cause an updated dynamic host configuration protocol procedure to be performed.

The message to cause the updated dynamic host configuration protocol procedure to be performed may comprise a dynamic host configuration protocol force renew message or a dynamic host configuration protocol reconfigure message.

The message to cause the updated dynamic host configuration protocol procedure to be performed may comprise a session management function session modification message with a protocol configuration option carrying an indication to trigger the updated dynamic host configuration protocol procedure to be performed

The means may be configured to advertise in a packet data unit session establishment that the updated dynamic host configuration protocol procedure for the communications device is triggered by one or more of a protocol configuration option and the dynamic host configuration protocol message

The apparatus may be or in a communications device.

According to another aspect, there is provided an apparatus, the apparatus comprising at least one processor and at least one memory including a computer program code, the at least one memory and computer program code configured to, with the at least one processor, cause the apparatus at least to: cause a request to be provided to a session management function requesting one or more an internet protocol addresses via a dynamic host configuration protocol; receive during establishment of a packet data unit session for a communications device, the one or more requested internet protocol addresses; and receive an internet protocol address of an edge application server discovery function allocated to the communications device.

The request may be provided in a protocol configuration option.

The at least one memory and at least one processor may be configured to cause the apparatus to receive a modified message wherein a dynamic host configuration protocol response message is modified to replace one of a domain name server internet protocol address and an internet protocol address of the edge application server discovery function with the other of the domain name server internet protocol address and the internet protocol address of the edge application server discovery to provide said modified message.

The dynamic host configuration protocol response message may comprise one of a dynamic host configuration protocol ACK message and a relay reply message.

The at least one memory and at least one processor may be configured to cause the apparatus to receive a message to cause an updated dynamic host configuration protocol procedure to be performed.

The message to cause the updated dynamic host configuration protocol procedure to be performed may comprise a dynamic host configuration protocol force renew message or a dynamic host configuration protocol reconfigure message.

The message to cause the updated dynamic host configuration protocol procedure to be performed may comprise a session management function session modification message with a protocol configuration option carrying an indication to trigger the updated dynamic host configuration protocol procedure to be performed

The at least one memory and at least one processor may be configured to cause the apparatus to advertise in a packet data unit session establishment that the updated dynamic host configuration protocol procedure for the communications device is triggered by one or more of a protocol configuration option and the dynamic host configuration protocol message

The apparatus may be or in a communications device.

According to another aspect, there is provided a method comprising: causing by a communications device a request to be provided to a session management function requesting one or more an internet protocol addresses via a dynamic host configuration protocol; receiving during establishment of a packet data unit session for the communications device, the one or more requested internet protocol addresses; and receiving an internet protocol address of an edge application server discovery function allocated to the communications device.

The request may be provided in a protocol configuration option.

The method may comprise receiving a modified message wherein a dynamic host configuration protocol response message is modified to replace one of a domain name server internet protocol address and an internet protocol address of the edge application server discovery function with the other of the domain name server internet protocol address and the internet protocol address of the edge application server discovery to provide said modified message.

The dynamic host configuration protocol response message may comprise one of a dynamic host configuration protocol ACK message and a relay reply message.

The method may comprise receiving a message to cause an updated dynamic host configuration protocol procedure to be performed.

The message to cause the updated dynamic host configuration protocol procedure to be performed may comprise a dynamic host configuration protocol force renew message or a dynamic host configuration protocol reconfigure message.

The message to cause the updated dynamic host configuration protocol procedure to be performed may comprise a session management function session modification message with a protocol configuration option carrying an indication to trigger the updated dynamic host configuration protocol procedure to be performed

The method may comprise advertising by the communications device in a packet data unit session establishment that the updated dynamic host configuration protocol procedure for communications device is triggered by one or more of a protocol configuration option and the dynamic host configuration protocol message

The method may be performed by an apparatus. The apparatus may be or in a communications device.

According to another aspect, there is provided an apparatus comprising means configured to: cause a request to be provided to a session management function requesting one or more internet protocol addresses via a dynamic host configuration protocol; receive the one or more requested internet protocol addresses, said requested internet protocol address being obtained via a dynamic host configuration protocol relay function; and receive an internet protocol address of an edge application server discovery function allocated to a communications device.

The request may be provided in a protocol configuration option.

The means may be configured to receive a modified message wherein a dynamic host configuration protocol response message is modified to replace one of a domain name server internet protocol address and an internet protocol address of the edge application server discovery function with the other of the domain name server internet protocol address and the internet protocol address of the edge application server discovery to provide said modified message.

The dynamic host configuration protocol response message may comprise one of a dynamic host configuration protocol ACK message and a relay reply message.

The means may be configured to receive a message to cause an updated dynamic host configuration protocol procedure to be performed.

The message to cause the updated dynamic host configuration protocol procedure to be performed may comprise a dynamic host configuration protocol force renew message or a dynamic host configuration protocol reconfigure message.

The message to cause the updated dynamic host configuration protocol procedure to be performed may comprise a session management function session modification message with a protocol configuration option carrying an indication to trigger the updated dynamic host configuration protocol procedure to be performed

The means may be configured to advertise in a packet data unit session establishment that the updated dynamic host configuration protocol procedure for the communications device is triggered by one or more of a protocol configuration option and the dynamic host configuration protocol message

The apparatus may be or in a communications device.

According to another aspect, there is provided a an apparatus, the apparatus comprising at least one processor and at least one memory including a computer program code, the at least one memory and computer program code configured to, with the at least one processor, cause the apparatus at least to: cause a request to be provided to a session management function requesting one or more internet protocol addresses via a dynamic host configuration protocol; receive the one or more requested internet protocol addresses, said requested internet protocol address being obtained via a dynamic host configuration protocol relay function; and receive an internet protocol address of an edge application server discovery function allocated to a communications device. The request may be provided in a protocol configuration option.

The at least one memory and at least one processor may be configured to cause the apparatus to receive a modified message wherein a dynamic host configuration protocol response message is modified to replace one of a domain name server internet protocol address and an internet protocol address of the edge application server discovery function with the other of the domain name server internet protocol address and the internet protocol address of the edge application server discovery to provide said modified message.

The dynamic host configuration protocol response message may comprise one of a dynamic host configuration protocol ACK message and a relay reply message.

The at least one memory and at least one processor may be configured to cause the apparatus to receive a message to cause an updated dynamic host configuration protocol procedure to be performed.

The message to cause the updated dynamic host configuration protocol procedure to be performed may comprise a dynamic host configuration protocol force renew message or a dynamic host configuration protocol reconfigure message.

The message to cause the updated dynamic host configuration protocol procedure to be performed may comprise a session management function session modification message with a protocol configuration option carrying an indication to trigger the updated dynamic host configuration protocol procedure to be performed

The at least one memory and at least one processor may be configured to cause the apparatus to advertise in a packet data unit session establishment that the updated dynamic host configuration protocol procedure for the communications device is triggered by one or more of a protocol configuration option and the dynamic host configuration protocol message

The apparatus may be or in a communications device.

According to another aspect, there is provided a method comprising: causing by a communications device a request to be provided to a session management function requesting one or more internet protocol addresses via a dynamic host configuration protocol; receiving the one or more requested internet protocol addresses, said requested internet protocol address being obtained via a dynamic host configuration protocol relay function; and receiving an internet protocol address of an edge application server discovery function allocated to the communications device.

The request may be provided in a protocol configuration option.

The method may comprise receiving a modified message wherein a dynamic host configuration protocol response message is modified to replace one of a domain name server internet protocol address and an internet protocol address of the edge application server discovery function with the other of the domain name server internet protocol address and the internet protocol address of the edge application server discovery to provide said modified message.

The dynamic host configuration protocol response message may comprise one of a dynamic host configuration protocol ACK message and a relay reply message.

The method may comprise receiving a message to cause an updated dynamic host configuration protocol procedure to be performed.

The message to cause the updated dynamic host configuration protocol procedure to be performed may comprise a dynamic host configuration protocol force renew message or a dynamic host configuration protocol reconfigure message.

The message to cause the updated dynamic host configuration protocol procedure to be performed may comprise a session management function session modification message with a protocol configuration option carrying an indication to trigger the updated dynamic host configuration protocol procedure to be performed

The method may comprise advertising by the communications device in a packet data unit session establishment that the updated dynamic host configuration protocol procedure for communications device is triggered by one or more of a protocol configuration option and the dynamic host configuration protocol message

The method may be performed by an apparatus. The apparatus may be or in a communications device.

According to another aspect, there is provided a computer readable medium comprising program instructions for causing an apparatus to perform at least the method according to any of the preceding aspects.

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows an example system architecture;

FIG. 2 shows a schematic diagram of an example 5G core network and radio access part;

FIG. 3 shows a schematic diagram of an example apparatus;

FIGS. 4a and 4b which show an edge application server discovery procedure with edge application server discovery function;

FIG. 5 shows a EAS deployment information management in a session management function procedure;

FIG. 6 shows for DHCP (dynamic host configuration protocol) IPv6 a configuration signal flow;

FIG. 7 shows a DHCPv4 signal flow;

FIG. 8 shows a packet data unit session establishment procedure; and

FIGS. 9 to 12 show flowcharts of methods performed by an apparatus according to various example embodiments.

### DETAILED DESCRIPTION

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

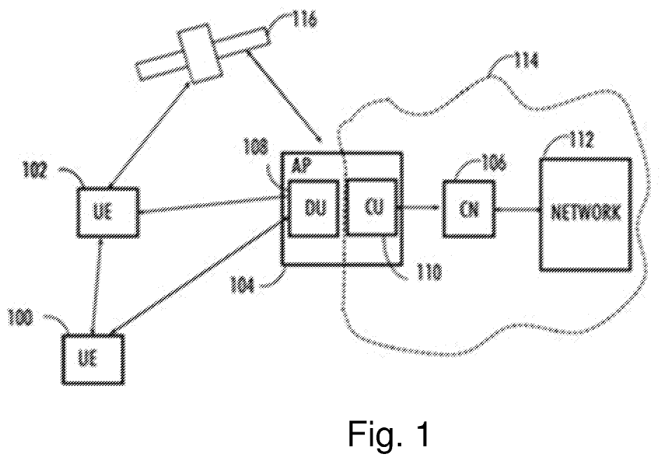

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 100 and 102. The devices 100 and 102 are configured to be in a wireless connection on one or more communication channels with a node 104. The node 104 is further connected to a core network 106. In one example, the node 104 may be an access node such as a base station or (e/g) NodeB serving devices in a cell. In one example, the node 104 may be a non-3GPP access node. The physical link from a device to a (e/g) NodeB is called uplink or reverse link and the physical link from the (e/g) NodeB to the device is called downlink or forward link. It should be appreciated that (e/g) NodeBs or their functionalities may be implemented by using any node, host, server, or access point etc. entity suitable for such a usage.

A communications system typically comprises more than one (e/g) NodeB in which case the (e/g) NodeBs may also be configured to communicate with one another over links, wired or wireless, designed for the purpose. These links may be used for signalling purposes. The (e/g) NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to devices. The antenna unit may comprise a plurality of antennas or antenna elements. The (e/g) NodeB is further connected to the core network 106 (CN or next generation core NGC). Depending on the deployed technology, the (e/g) NodeB is connected to a serving and packet data network gateway (S-GW and P-GW) or Session Management Function or user plane function (UPF), for routing and forwarding user data packets and for providing connectivity of devices to one or more external packet data networks, and to a mobile management entity (MME) or access mobility management function (AMF), for controlling access and mobility of the devices.

Exemplary embodiments of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, a wireless interface card or other wireless interface facility (e.g., USB dongle) and multimedia device. It should be appreciated that a device may also be a nearly exclusive uplink only device, of which an example is a camera or video camera loading images or video clips to a network. The device may be a machine-type communications (MTC) device or an Internet of things (IoT) type communication device. The device may be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones, or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors, and real-time control). 5G is expected to have multiple radio interfaces, e.g. below 6 GHz or above 24 GHZ, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHZ-cmWave, 6 or above 24 GHZ-cm Wave and mm Wave).

One of the concepts considered to be used in 5G networks is network slicing in which multiple independent and dedicated virtual sub-networks (network instances) may be created within the same infrastructure to run services that have different requirements on latency, reliability, throughput, and mobility. As part of the 5G system, a service management part may be provided.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets, and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes, or hosts. Application of cloud RAN architecture enables RAN real time functions being carried out at or close to a remote antenna site (in a distributed unit, DU 108) and non-real time functions being carried out in a centralized manner (in a centralized unit, CU 110).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or NodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g) NodeBs, the device may have access to a plurality of radio cells and the system may comprise also other apparatuses, such as physical layer relay nodes or other network elements, etc. At least one of the (c/g) NodeBs or may be a Home (e/g) NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

For fulfilling the need for improving the deployment and performance of communication systems, the concept of “plug-and-play” (e/g) NodeBs has been introduced. Typically, a network which is able to use “plug-and-play” (e/g) Node Bs, includes, in addition to Home (e/g) NodeBs (H (e/g) gNodeBs), a home node B gateway, or HNB-GW (not shown in FIG. 1). A HNB Gateway (HNB-GW), which is typically installed within an operator's network may aggregate traffic from a large number of HNBs back to a core network.

In the following examples, the communications device is referred to as a UE. However, it should be appreciated that the communication device can any suitable communications device, some examples of which have already been mentioned.

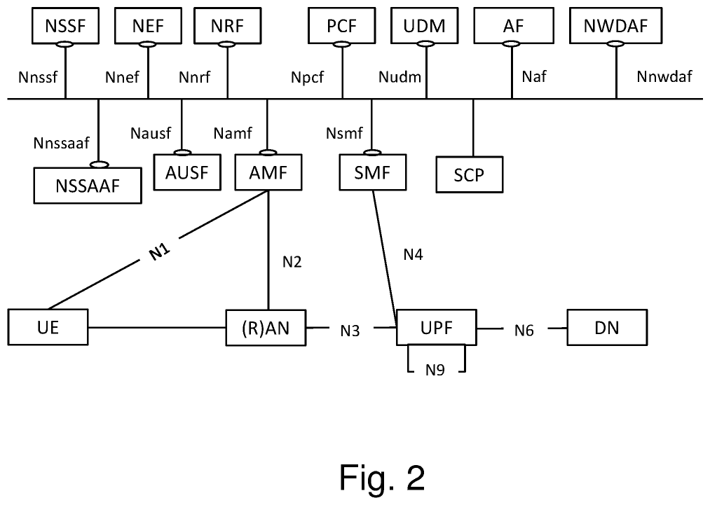

FIG. 2 shows a schematic representation of part of a 5G system (5GS). The 5GS may be comprised by a terminal or user equipment (UE), a 5G radio access network (5GRAN) or next generation radio access network (NG-RAN), a 5G core network (5GC), one or more application functions (AF) and one or more data networks (DN).

Currently, a DNS (domain name server) can be configured at the SMF or retrieved by the SMF from the DHCP (dynamic host configuration protocol) server. DHCP is a network management protocol used for example on IP networks for assigning IP addresses. In case of the DHCP server solution at the SMF it is possible to only have one DHCP server in the operator's network and the determination of the IP Address of UE and DNS is centralized.

According to TS 23.548 chapter. 6.2.3.2.2, the SMF signals the IP address of the EASDF (edge application server discovery function) in the information element DNS Server IPv4 or DNS Server Ipv6 address of the PCO (protocol configuration options), if requested by the UE in the PCO in the session establishment phase.

However, the inventors have identified some issues with TS 23.548.

TS 23.548 does not recognise the need for the SMF to explicitly instruct the EASDF to forward the DNS request for not matching FQDNs (fully qualified domain server) to the DNS server addresses configured in the SMF.

Currently, the EASDF forwards a DNS request not matching a FQDN as available from the EAS (edge application server) deployment information to a locally configured DNS resolver. However this approach does not address the case that the SMF and therefore also the UE has been configured with a DNS server in parallel via EAS deployment information.

The approach currently set out in 3GPP TS 23.548 may not work where the SMF was configured locally with a DNS server or retrieves this from DHCP server

A UE may get a UE IP address and DNS server IP addresses via DHCP. The discovery procedure in TS 23.548 does not consider the case where the UE requests the allocation of UE IP address based on a DHCPv4 procedure. The EAS discovery procedure in TS 23.548 only considers the case where the UE requests the UE IP Address be sent from the 5GS in the PCO (protocol configuration options) back to the UE.

If the UE requests its IP address via the DHCP procedure, where the SMF hosts the DHCP relay agent, the IP address allocation can only take place after a successful PDU session establishment. That means that the context at the EASDF (edge application server discovery function) can only be meaningfully created after the PDU session establishment has been completed, because the UE IP address is mandatory in the Neasdf_DNSContextCreateRequest. So in that scenario, context allocation does not work as of current specification. Some embodiments propose that it is postponed until after successful completion of DHCP procedure. This may be disadvantageous in some scenarios. Alternatively, in some embodiments a new identifier (this is referred to a correlation ID in this document which may take any suitable form) is added to the Neasdf_DNSContextCreateRequest or similar as a help until the UE IP address is available. This ID may be regarding as providing a placeholder function in some embodiments.

Furthermore the EAS discovery procedure in TS 23.548 does not consider the case where the UE requests the allocation of the DNS server IP address based on DHCP procedure. If the UE requests a DNS server IP address via the DHCP procedure, where the SMF hosts the DHCP relay agent, this can only take place after the successful PDU session establishment. That means that the context at the EASDF relating to additional alternative DNS resolvers beside the default DNS resolver configured locally at the EASDF needs to be postponed or the correlation ID is added to Neasdf_DNSContextCreateRequest instead which would avoid the need to postpone. In this scenario an additional EASDF context update needs to be performed after successful completion of DHCP procedure. This means that the interaction of the DHCP procedure, carrying the UE IP address allocation and the signalling DNS server, with EASDF discovery procedure is missing in the current specification.

Re-allocation/removal of EASDF—in the case of DHCP usage the EASDF discovery procedure does not consider the EASDF re-allocation/removal as for example happening during handover from EPS (evolved packet system) to 5GS. When a PDN connection is initiated in EPS, the SMF and PGW-C (PDN (packet data network) gateway control plane function) can also select a normal DNS Server (i.e. different from an EASDF) to serve the PDN connection, and then indicate to the UE to use the EASDF as a DNS Server when the PDU Session/PDN connection is moved to 5GS. For example, if the EASDF has been allocated and activated and is to be de-activated in a next step or in the case of a DHCP configuration change, the UE needs to be updated on the new/final DNS server IP addresses as the EASDF was deactivated. TS 23.548 is thus silent on the interaction of DHCP with the EASDF (re-) discovery procedure.

Consider some embodiments where the DNS server IP addresses are configured at the SMF or retrieved by the SMF from the DHCP server.

In some embodiments, during PDU session establishment, the SMF retrieves (and evaluates) the DNS server IP address. The DNS server IP address may be obtained from its local database or from the DHCP response carrying the IP address of e.g. the DNS server.

If the DNS server IP addresses (for example see chapter 10.2.4 of TS 29561 which allows multiple responses from multiple DNS servers) does not match one of the DNS IP addresses provided by existing the EAS deployment information and if EASDF had been allocated for this PDU session, the SMF may instruct the EASDF to forward DNS queries to the DNS Server if the FQDN of the DNS query are not matched.

In the case of DHCPv6 there might be several different DNS server responses from the several different DHCP servers, but these DNS responses are not be reported from the EASDF to the SMF.

If the EASDF matches a DNS server IP address which had been configured both in the DHCP sever and configured by EAS deployment information, this may be considered to be a configuration error. This may be reported to the OAM (operation administration and maintenance).

The same may be true for a P-CSCF (proxy-call session control function) FQDN/IP address. If a P-CSCF matches a P-CSCF server FQDN/IP address which had been configured both in the DHCP sever and configured by EAS deployment information, this may be considered to be a configuration error. This may be reported to the OAM.

Alternatively or additionally the SMF populates (or has already populated) the DNS server IP address in the PCO with the IP address of the EASDF and sends the IP address of the EASDF to the UE. This may be done even if the UE requested a IPv4/IPv6 SMF IP address via the DHCP during the PDU session establishment phase. In this latter case the UE may adhere to the IP address received in the PCO and the UE may ignore the content of the DHCP response during the DHCP procedure later on after the PDU session establishment.

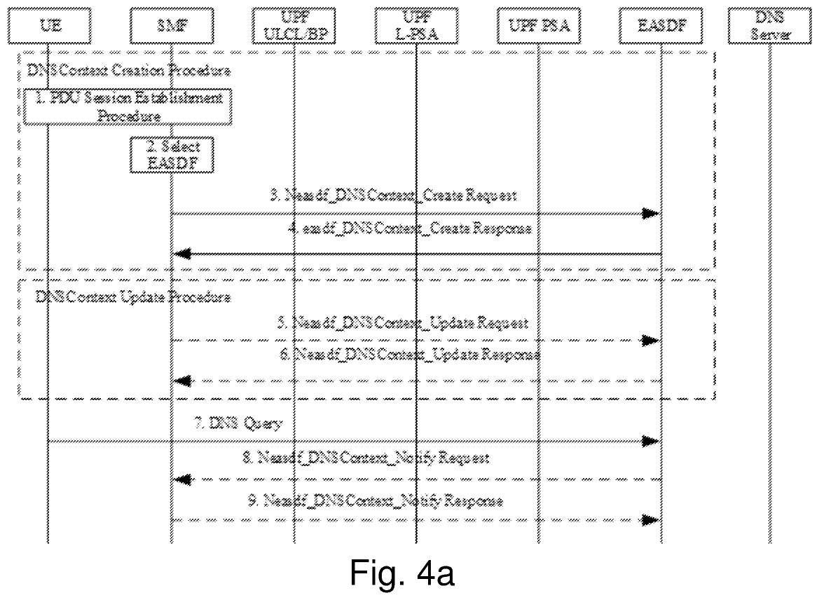

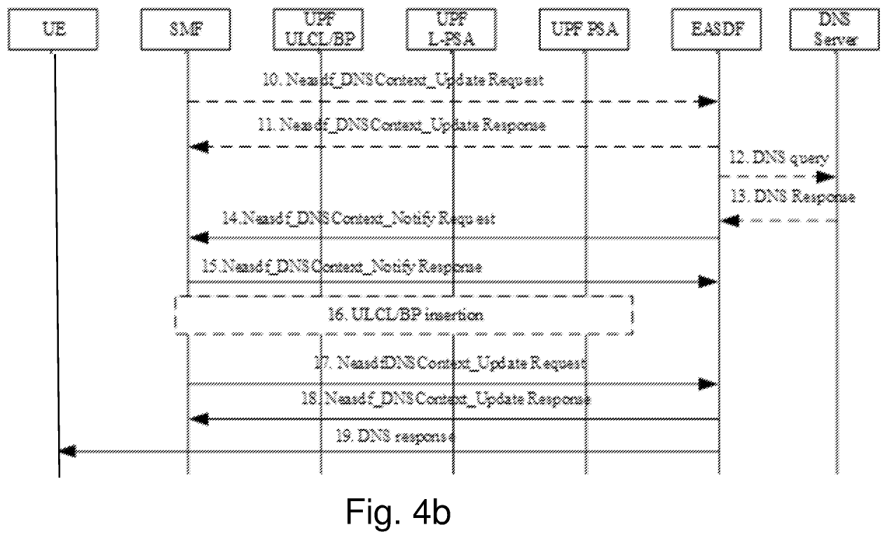

Alternatively in a first step, the SMF may not support the DHCP relay agent function, but terminates the DHCP protocol initiated by the UE at the SMF. In that way the SMF would be free to silently allocate the UE IP address during the session establishment phase and does not need to postpone the context create request (This is referenced 3 in FIG. 4a which is described in more detail later). However, the EASDF needs to be instructed to forward DNS queries for not matching FQDNs to the DNS servers signalled in DHCP and the SMF needs to insert the IP address of the EASDF into the DHCP signalling.

3rd parties DHCP servers (i.e. corporate users) are excluded from Rel.17 of the 5G standardization. There is the risk that at PDU session establishment no EASDF was involved and the DHCP relay agent function therefore was allowed, but later on, the AF may configure EAS deployment information for that PDU session.

Various options for addressing this problem are provided by embodiments and are as follows:
Option A: The EASDF would be allowed to be allocated and the SMF would need to send DHCP force renew (for example as defined in RFC3203) or DHCP reconfigure (for example as defined in RFC6644) to the UE and interception/inspection DHCP messages in the DHCP relay function and associated interaction with the EASDF have already be discussed. This option may be used to provide support for a relay function solution. This option may alternatively or additionally be used to provide support for DHCP requests from a UE where EASDF is being used
Option B: EASDF does not work in this case, as the UE does not get aware of the new DNS server IP address
Option C: SMF sends the new IP address of new EASDF in the PCO even for UE's which explicitly requested DHCP.
Option D: Do not allow DHCP relay function in SMF for all users in Rel. 17, even for those who will never make use of EASDF functions
Option E: AF may not make use of “any user” in AF requests, such that only known and dedicated users or group of UEs which are not corporate users which rely on DHCP relay agent in the SMF, make use of the EASDF functionality.

For the case of DHCP servers (i.e. corporate users) being excluded from a particular version of the standard, option C may be used. Alternatively any of the other options A to E may be used. Alternatively instead the SMF may be sent the UE IP address within the PCO parameter, even if the UE did not request to receive the IP address via 5GS/PCO procedures. In this case the UE ignores the IP address in the DHCP response if the IP address is not same as received via the PCO procedure.

The case where the UE gets the UE IP address and DNS server via DHCP will now be discussed.

In this case it is suggested that during PDU session establishment the SMF either allocates the EASDF with the help of the correlation ID of some embodiments but postpones the configuration of the UE IP addresses and all the DNS server IP addresses at the EASDF until the DHCP procedure is completed or the SMF does not allocate the EASDF during PDU session establishment at all, but completely postpones the allocation of the EASDF until the DHCP procedure is completed and only after that allocates and configures the EASDF.

In some embodiments, the SMF replaces the DNS server IP address in the DHCP response sent from the DHCP server to the DHCP relay agent in the SMF by the IP address of the EASDF that has been allocated.

Alternatively in a first step, the SMF may not support the DHCP relay agent function, but terminates the DHCP protocol initiated by the UE at the SMF. In that way the SMF would be free to silently allocate the UE IP address during the session establishment phase and does not need to postpone the context create request (This is referenced 3 in FIG. 4a which is described in more detail later).

The case of re-allocation, allocation, de-allocation of EASDF/DNS server will now be discussed.

In general there are several triggers leading to allocation and re-/de-allocation of EASDF, for example handover from EPS to 5GS, handover from 5GS to EPS and receipt of adding/removal of EAS deployment information and/or de-/re-activation of function at the EASDF.

If the UE got the UE IP address and/or DNS IP address via DHCP means it is suggested that upon allocation and/or re-/de-allocation of EASDF like change of EAS deployment information or handover between EPS and 5GS the SMF instructs the UPF to issue a request for an update to the UE or the like.

Change of EAS deployment information-if EAS deployment information is changed, e.g. removal, addition, change of DNS server IP address, the EASDF may be removed/added and the DNS server IP address allocated by the DHCP relay agent/server may be (re-) submitted to the UE or the EASDF IP address may be (re-) submitted to the UE.

In some embodiments, the SMF sends the DHCP force renew message for IPV4 as defined in RFC3203 “DHCP reconfiguration” or DHCP reconfigure message for IPV6 RFC6644 “Rebind Capability in DHCPv6 Reconfigure Messages” or any other suitable message towards the UE via the UPF or via a NAS information element towards the UE via the AMF e.g. by PCO with e.g. an information element for this purpose.

This triggers the UE to send a DHCP discover message and the DHCP Relay agent of the SMF gets the chance to insert the new DNS server IP address of the EASDF into the DHCP response sent from the DHCP server to the UE as for the PDU session establishment.

This may prevent the SMF from needing to store the DNS/P-CSCF data for PDU sessions where there is no EAS deployment information available.

If EAS deployment information is withdrawn for the PDU session then again the DHCP force renew message or the DHCP reconfigure message or the NAS information element “request DHCP configuration” may be used in order to re-configure the (original DNS) server at the UE.

Some embodiments may be used for handover between EPS and 5GS. If a UE is handed over from EPS to 5GS potentially the EASDF may be added to the PDU session, whereas if the UE moves from 5GS to EPS the EASDF may be removed. (The EASDF is a 5G functionality). That is due to the fact the procedures of re-allocation of BP/UL CL (branching point/uplink classifier) UPF and PSA (PDU session anchor) UPF is not available in the EPS.

In order to be able to inform the UE about the changes of the actual DNS server, in some embodiments the SMF/PGW-C sends the DHCP force renew message for IPV4 or DHCP reconfigure message for IPV6 towards the UE via the UPF/PGW-U (PDN gateway user plane function) or a new NAS information element towards the UE via the AMF e.g. by PCO with e.g. an information element for this purpose.

This triggers the UE to send DHCP discover message for IPV4 and the DHCP Relay agent of the SMF gets the chance to insert the new DNS server IP address of the EASDF into the DHCP response sent from the DHCP server to the UE as described for the PDU session establishment.

This prevents the SMF/PGW-C from needing to store the DNS/P-CSCF data for PDU sessions where there is no EAS deployment information available.

If at the beginning during the PDU session establishment no EAS deployment information is available, it might be questionable whether the SMF should store DNS server FQDN/IP addresses and P-CSCF FQDN/IP addresses preventively. In order to limit the storage requirement in the SMF, in some embodiments, once EAS deployment information is available for the established PDU session the SMF allocates the EASDF and triggers the UE either via NAS (non access stratum) e.g. by PCO with e.g. an information element for this purpose, or DHCP force renew or reconfigure messages to request new configuration data from the DHCP server. During this DHCP message exchange the relay agent in the SMF gets to know the DNS and P-CSCF details in order to be able to instruct the EASDF to handle DNS query correctly.

Some embodiments where the DNS server is configured at the SMF or retrieved by the SMF from the DHCP server will be described. In some embodiments, the UE get the UE IP address and DNS server via DHCP

Reference is made to FIGS. 4a and 4b which show a EAS discovery procedure with EASDF. This may be for the case where there is no relay function. The signal flow starts in FIG. 4a and continues to FIG. 4b. The signal flow may be generally as set out in TS 23.502 with various modifications which are highlighted below.

As referenced 1, a PDU session establishment procedure in performed between the UE and SMF. As part of this procedure, the UE sends a PDU session establishment request to the SMF. (The PDU session establishment is described later with reference to FIG. 8.)

As referenced 2, during the PDU Session Establishment procedure, the SMF selects an EASDF. The SMF may consider the UE subscription information when selecting an EASDF as the DNS server of the PDU Session. If the SMF, based on local configuration, decides that the interaction between EASDF and DNS Server in the DN is to go via the PSA UPF, the SMF configures the PSA UPF within N4 rules to forward the DNS message between the EASDF and the DN.

As referenced 3, the SMF invokes a context create request to the selected EASDF. The request may be a Neasdf_DNSContext_Create Request. The request may comprise one or more of UE IP address, SUPI (Subscription Permanent Identifier), DNN (data network name), notification endpoint, and DNS message handling rules.

In some embodiments, if the UE requested the UE IP address and/or DNS server address allocation via DHCP, the SMF invokes the DHCP server functionality and allocates UE IP address and/or DNS server address. Where the UE requested the UE IP address and/or DNS server address allocation via DHCP, this may be included in the PDU session establish request referenced 1 in FIG. 8 or otherwise sent to the SMF. The SMF may invoke the SMF invokes the DHCP server functionality and allocate UE IP address and/or DNS server address before or after the SMF EASDF selection is performed. It should be appreciated that the steps of request by the UE of the UE IP address and/or DNS server address allocation via DHCP, and the invoking of the DHCP server functionality and allocating of UE IP address and/or DNS server address may be performed before step 11 of PDU Session Establishment procedure in clause 4.3.2.2.1 of TS 23.502. (This procedure is shown in FIG. 8 described later). In other words, these steps may be performed before the PDU sessions has been established and may be part of the PDU session establishment procedure.

After this step, in some embodiments, if the UE did not request the UE IP address and/or the DNS server IP address via the DHCP, the SMF includes the IP address of the EASDF as DNS server/resolver for the UE in the PDU Session Establishment Accept message. This may be as defined in step 11 of clause 4.3.2.2.1 of TS 23.502. The UE configures the EASDF as DNS server for that PDU Session.

The EASDF creates a DNS context for the PDU Session and stores the UE IP address, SUPI, the notification endpoint and potentially the provided DNS message handling rule(s) conditionally containing the DNS server IP address allocated before step 11 of clause 4.3.2.2.1 of TS 23.502 into the context.

The EASDF is provisioned with the DNS message handling rule(s) containing rule about the DNS server IP addresses before the DNS query message is received at the EASDF or as a consequence of the DNS query reporting.

As referenced 4, the EASDF invokes the service operation response. This may be a Neasdf_DNSContext_Create Response.

The procedures referenced 1 to 4 provide a DNS context creation procedure. If a context update procedure is required, then the procedures referenced 5 and 6 are carried out.

As referenced 5, the SMF may invoke an update request to the EASDF e.g. after session establishment. The request may be a Neasdf_DNSContext_Update Request. The update request may comprise a EASDF Context ID, and DNS message handling rules. The update may be triggered by UE mobility, e.g. when UE moves to a new location, by a reporting by the EASDF of a DNS Query with certain FQDN, by insertion/removal of Local PSA, e.g. to update rules to handle DNS messages from the UE, or by a new PCC rule information or because of consideration of the successful DHCP exchange e.g. relay function.

As referenced 6, the EASDF responds with an updated response. The update response may be a Neasdf_DNSContext_Update response.

In some embodiments, if the UE requested a UE IP address and/or DNS server address allocation via DHCP, the DHCP server functionality on the SMF responds to the DHCP request sent by the UE with UE IP address allocated as previously discussed in relation to the DNS context creation procedure and/or DNS server address containing the IP address of the EASDF as selected in in the procedure referenced 2.

As referenced 7, the UE sends a DNS query message to the EASDF. This will either be after the DNS context creation procedure or after the DNS context update procedure.

As referenced 8, if the DNS query message matches a DNS message handling rule for reporting, the EASDF sends the DNS message report to SMF by invoking a notify request. The notify request may be a Neasdf_DNSContext_Notify Request. The request may comprise information from the DNS Query e.g. target FQDN of the DNS Query. In some embodiments, otherwise the EASDF forwards the DNS query containing FQDNs, which do not match the DNS message handling rule to DNS resolvers in accordance with DNS message handling rules. For example this may be a DNS server IP address allocated/requested by UE via DHCP request.

As referenced 9, the SMF responds with a notify response. This notify response may be a Neasdf_DNSContext_Notify response.

The signal flow continues on FIG. 4b.

As referenced 10, if the DNS message handling rule for the FQDN received in the report needs to be updated, e.g. provide updates to information to build the EDNS Client Subnet option information, the SMF invokes a context update message to the EASDF. The context update message may be a Neasdf_DNSContext_Update Request. The context update message may comprise DNS message handling rules.

In some arrangements supporting option A (discussed previously), the DNS handling rule includes a corresponding IP address to be used to build the EDNS client subnet option. For arrangements supporting option B (discussed previously), the DNS handling rule includes corresponding Local DNS Server IP address. The EASDF may be instructed by the DNS handling rule to simply forward the DNS Query to a pre-configured DNS server/resolver.

As referenced 11, thee EASDF responds with a context update response. The context update response may be a Neasdf_DNSContext_Update Response.

As referenced 12, the EASDF handles the DNS Query message received from the UE as follows:

For Option B, the EASDF sends the DNS Query message to the local DNS server.

If no DNS message detection template within the DNS message handling rule provided by the SMF matches the requested FQDN in the DNS Query, the EASDF may simply send a DNS Query to a pre-configured DNS server/resolver.

As referenced 13, the EASDF receives DNS Responses from the DNS system and determines that a DNS Response can be sent to the UE.

As referenced 14, the EASDF may send a DNS message reporting to the SMF by invoking a context notify request. The context notify request may be a Neasdf_DNSContext_Notify request. The notify request may include EAS information if the EAS IP address or the FQDN in the DNS Response message matches the reporting condition provided by the SMF. The DNS message reporting may contain multiple EAS IP addresses if the EASDF has received multiple EAS IP address(es) from the DNS servers it has contacted. The DNS message reporting may contain the FQDN and the EDNS Client Subnet option received in the DNS Response message.

Per the received DNS message handling rule, the EASDF does not send the DNS Response message to the UE but waits for SMF instructions (see the procedure referenced 17), i.e. buffering the DNS Response message.

If the DNS response(s) is required to be buffered and reported to the SMF, when the reporting-once control information is set, the EASDF only reports to SMF once by invoking a context notify request for DNS responses matching with the DNS message detection template. The context notify request may be a Neasdf_DNSContext_Notify request.

As referenced 15, the SMF invokes a context notify response service operation. The context notify response may be a Neasdf_DNSContext_Notify response.

As referenced 16, the SMF may perform UL CL/BP and Local PSA selection and insert UL CL/BP and local PSA.

Based on EAS information received from the EASDF in a context notify (for example a Neasdf_DNSContext_Notify) message, other UPF selection criteria, (for example as specified in clause 6.3.3 in TS 23.501, and possibly service experience or DN performance analytics for an edge Application (for example as described in TS 23.288), the SMF may determine the DNAI (data network access identifier) and determine the associated N6 traffic routing information for the DNAI. The SMF may perform UL CL/BP and Local PSA selection and insertion, for example as described in TS 23.502. In the case of UL CL, the traffic detection rules and traffic routing rules are determined by the SMF based on IP address range(s) per DNAI included in the EAS deployment information.

As referenced 17, the SMF invokes a context update request. The context update request may be a Neasdf_DNSContext_Update Request. The context update request may comprise DNS message handling rules.

The DNS message handling rule may indicate the EASDF to send a DNS Response buffered in the procedure referenced 14 to the UE. Other DNS message handling rules may indicate that the EASDF is not to send further DNS Response message corresponding to FQDN ranges and/or EAS IP address ranges.

As referenced 18, the EASDF responds with a context update response. This may be a Neasdf_DNSContext_Update response.

As referenced 19, the EASDF sends the DNS response to the UE. During the PDU session release procedure, the SMF removes the DNS context by invoking a delete service. The delete service may be a Neasdf_DNSContext_Delete service.

This procedure may be modified to support a DHCP relay function with a DHCP initiated by the UE. In this embodiment, in the step 11 of the PDU session establishment procedure, the UE IP address in the PCO may have set to 0.0.0.0 or any suitable ccorrelation ID. In this scenario an additional EASDF context update needs to be performed after successful completion of DHCP procedure.

An alternative discovery procedure with EASDF with a DHCP relay function with a DHCP initiated by the UE is described with reference to FIGS. 4a and 4b Those parts of the procedure which are the same as previously discussed for the situation where the is no relay function will not be discussed again.

As referenced 3, the SMF invokes a context create request to the selected EASDF. The request may be a Neasdf_DNSContext_Create Request. The request may comprise one or more of UE IP address, SUPI, DNN, notification endpoint, and DNS message handling rules.

In some embodiments, if the UE requested the UE IP address and/or DNS server address allocation via DHCP, the SMF invokes the DHCP relay functionality and postpones the procedures 3 to 6 until the DHCP servers have allocated UE IP address and/or DNS server addressess. The timing of the request may be as discussed in relation to the previous example.

These steps may be performed before step 11 of PDU Session Establishment procedure in clause 4.3.2.2.1 of TS 23.502 and as shown in FIG. 8.

After this step, in some embodiments, if the UE did not request the UE IP address and/or the DNS server IP address via the DHCP, the SMF includes the IP address of the EASDF as DNS server/resolver for the UE in the PDU Session Establishment Accept message. This may be as defined in step 11 of clause 4.3.2.2.1 of TS 23.502. The UE configures the EASDF as DNS server for that PDU Session.

The EASDF creates a DNS context for the PDU Session and stores the UE IP address, SUPI, the notification endpoint and potentially the provided DNS message handling rule(s) into the context.

The EASDF is provisioned with the DNS message handling rule(s) before the DNS query message is received at the EASDF or as a consequence of the DNS query reporting.

As referenced 6, the EASDF responds with an updated response. The update response may be a Neasdf_DNSContext_Update response.

In some embodiments, if the UE requested IP address allocation for IPV6 or via DHCPv4 in the PCO, the UE performs a DHCP procedure (for example as described in TS 29561 chapters. 10.2.2 and 10.2.4.) The SMF acts as a DHCP relay agent. The SMF retrieves the UE IP address allocated by DHCP and the SMF inspects the DHCP ACK response message (IPv4) and RELAY reply message (IPv4) to replace the DNS server IP address with the IP address of the EASDF and forwards the DHCP message to the UE. The UE accepts the information in accordance with existing DHCP procedures. Additionally the SMF also retrieves the UE IP addresses and configures the EASDF with UE IP address and with all the DNS server IP addresses to which the DNS traffic not matching any of the DNS related EAS deployment information is to be forwarded.

Next as part of procedure 6 of some embodiments, the SMF invokes a context create request to the selected EASDF. The context create request may be a Neasdf_DNSContext_Create Request. The context create request may comprise a UE IP address, a SUPI, a DNN, notification endpoint, and DNS message handling rules.

The EASDF creates a DNS context for the PDU Session and stores the UE IP address, the SUPI, the notification endpoint and potentially provided DNS message handling rule(s) conditionally containing the DNS server IP address (which may be allocated before step 11 of clause 4.3.2.2.1 of TS 23.502 as shown in FIG. 8) into the context. It should be appreciated that in the case of the DHCP relay, the allocation may be done before step 11 where the proposed correlation ID option is used.

The EASDF is provisioned with the DNS message handling rule(s) before the DNS query message is received at the EASDF or as a consequence of the DNS query reporting.

Next as part of procedure 6 of some embodiments the EASDF invokes the service operation with context create response. The context create response may be a Neasdf_DNSContext_Create Response.

As referenced 8, if the DNS query message matches a DNS message handling rule for reporting, the EASDF sends the DNS message report to SMF by invoking a notify request. The notify request may be a Neasdf_DNSContext_Notify Request. The request may comprise information from the DNS Query e.g. target FQDN of the DNS Query. In some embodiments, otherwise the EASDF forwards the DNS query containing FQDNs, which do not match the DNS message handling rule. to DNS resolvers in accordance with DNS message handling rules. For example this may be a DNS server IP address allocated by the UE via a DHCP request.

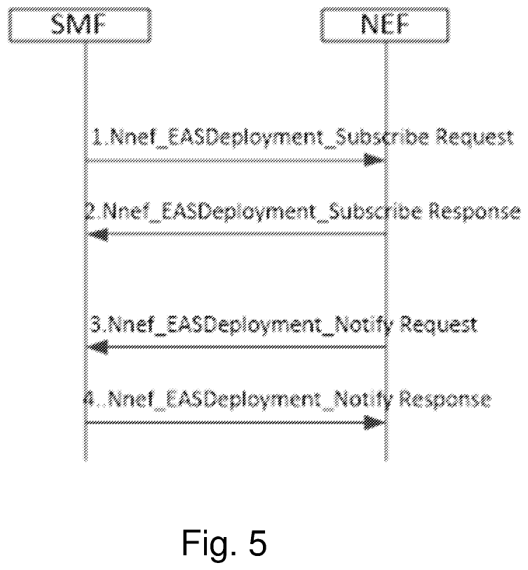

Re-allocation of EASDF will now be described with reference to FIG. 5. FIG. 5 shows a EAS deployment information management in a SMF procedure.

Some embodiments may provide a change of EAS deployment information.

The SMF may receive the EAS Deployment Information from the UDR (unified data repository via the NEF (network exposure function), via a subscribe/notify such as shown in the FIG. 5.

As referenced 1, as a pre-requisite condition, the SMF subscribes to a EAS deployment information change notification from the NEF by sending a subscribe request message to the NEF. The subscribe message may be a Nnef_EASDeployment_Subscribe request message. The SMF indicates that the current status of EAS Deployment Information may be notified immediately (if available). The SMF may indicate for which (list of) DNN and/or S-NNSAI it subscribes.

As referenced 2, the NEF replies to the SMF with a subscribe response message. The subscribe response may be a Nnef_EASDeployment_Subscribe response message.

As referenced 3, the NEF invokes a notify request to the SMF(s) to which the EAS deployment information is to be provided. The notify request may be a Nnef_EASDeployment_Notify request. The request may comprise DNN and/or DNAI(s) and/or application(s), and EAS Deployment Information). If there is EAS Deployment Information available and immediate report is required, the NEF notifies the SMF(s) with such information. The NEF may decide to delay the distribution of EAS Deployment Information to the SMF(s) for some time to optimize the signalling load.

In some embodiments, if the UE requested DNS Server IP addresses via DHCP, on receipt of the notify request the SMF checks whether DNS server IP addresses had been changed in the EAS deployment Information.

If all the DNS server IP addresses for an already associated FQDN range had been removed, the SMF may send a DHCP force renew for IPV4 such as defined in RFC3203 “DHCP reconfiguration” or DHCP reconfigure for IPV6 such as defined in RFC6644 “Rebind Capability in DHCPv6 Reconfigure Messages” towards the UE via the UPF for each DNS server IP address that had been part of the DHCP messages.

If at least one DNS server IP address for a complete new FQDN range has been added, the SMF may send DHCP force renew for IPV4 as defined in RFC3203 “DHCP reconfiguration” or DHCP reconfigure for IPV6 RFC6644 “Rebind Capability in DHCPv6 Reconfigure Messages” towards the UE via the UPF for each DNS server IP address that had been part of the DHCP messages.

As referenced 4, the SMF sends a notify response message to the NEF.

Reference is made to FIG. 6 which shows for DHCP IPv6 another configuration signal flow. A UE that has obtained an IPV6 address may use stateless DHCP to request other configuration information such as a list of DNS recursive name servers or SIP servers.

For 3GPP networks, when an external DHCPv6 server in a DN is used to obtain the requested parameters, the SMF acts as a DHCPv6 client towards the external DHCPv6 server while acting a DHCPv6 server towards the UE.

The IPV6 parameter configuration via stateless DHCPv6 function in the UE, the SMF and the external DHCPv6 Server may be compliant with IETF RFC 3736. The following system procedure describes the signalling flows for the IPV6 parameter configuration via stateless DHCPv6 procedures for a 5G system. All messages in the following steps between the UE and the SMF are sent via the UPF (not shown).

As referenced 1, a router Advertisement with the O-flag (override flag) set, is sent from SMF to UE to indicate to the UE that is should retrieve other configuration information. When set, the O-bit indicates that the advertisement should override an existing cache entry and update the cached link-layer address.

As referenced 2, the UE sends an information request message with the IP destination address set to the all_DHCP_Relay_Agents_and_Servers multicast address, for example as defined in DHCPv6 IETF RFC 3315. The source address is the link-local address of the UE. The DHCP relay agent in the SMF may forward the message to the Intranet or ISP DHCP servers.

As referenced 3, the DHCP servers receiving the forwarded information request message, reply by sending a relay reply message, with the “Relay Message” option including a reply message with the requested configuration parameters. In some embodiments, the SMF may replace the DNS Server IP addresses in all DHCP replies if at least one DNS server IP address for a complete new FQDN range has been added and a EASDF has been allocated.

The UE chooses one of the possibly several reply messages and extracts the configuration information.

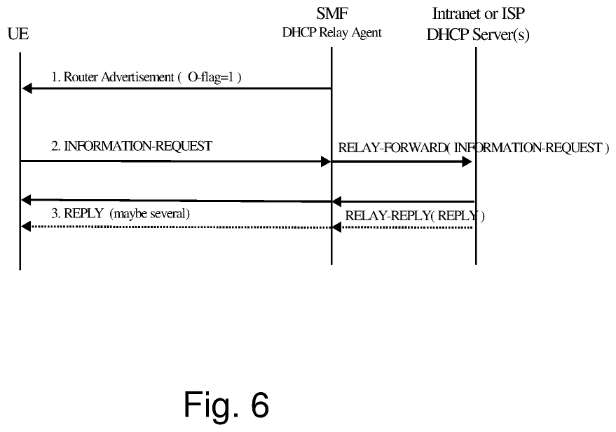

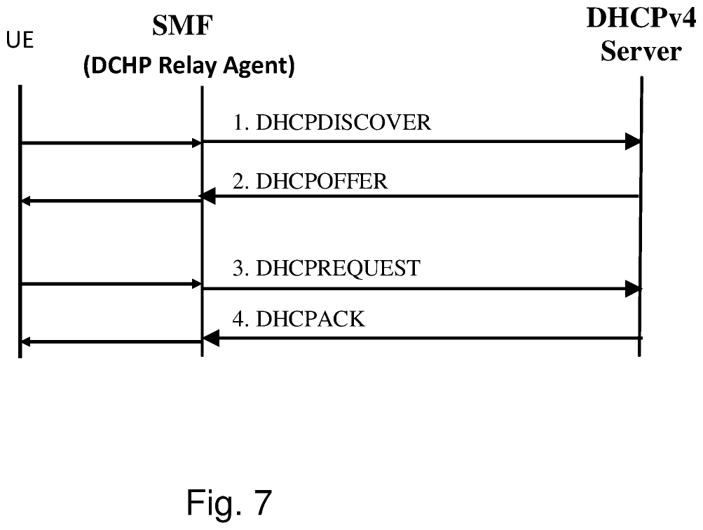

Reference is made to FIG. 7 which shows a DHCPv4 relay agent signal flow. The following system procedure describes the successful IPv4 address allocation and parameter configuration signalling flow between the UE, SMF and the external DHCPv4 server.

As referenced 1, a UE sends a DHCP discover message with the IP destination address set to the limited broadcast address (all 1s). The SMF will pass the DHCP discover message to the DHCP relay agent which will relay the request to the DHCP server configured for the DNN (Data Network Name) of the PDP context. If more than one DHCP server is configured for a given DNN, the request will be sent to all of them. The DHCP relay agent will add enough information to the DHCP discover message to be able to relay the replies back to the UE.

As referenced 2, upon receiving the DHCP discover request message, the external DHCPv4 servers reply by sending a DHCP offer message including an offered IP address. Several DHCP offer messages may be received by the SMF if multiple DHCPv4 servers respond to the DHCP discover. The DHCP relay agent forwards the replies to the UE.

As referenced 3, a UE chooses one of the possibly several DHCP offers and sends a DHCP request message confirming its choice and requesting additional configuration information. The relay agent relays the DHCP offer the DHCP server as explained in step 1.

As referenced 4, upon receiving the DHCP request message, the selected external DHCPv4 server replies with a DHCP ACK message containing the configuration information requested by the UE. The DHCP relay agent relays the DHCPACK to the UE.

In some embodiments, instead of making use of the DHCP signalling described above, even for cases where the UE requested DHCP procedure during the PDU session establishment, the SMF may signal new DNS server IP address (as set out as option C previously) to the UE.

It should be appreciated that the procedures of some embodiments enable the SMF to receive EAS deployment information when a PDU session for the DNN is established and EAS deployment information provided by the NEF is not available at the SMF.

Handover may be supported in some embodiments.

As traffic offload via UL CL/BP is not supported over EPC, when a PDN connection is initiated in EPS or a PDU Session is handed-over to EPS, the SMF and PGW-C can send to the EASDF DNS message handling rules requesting the EASDF to transparently forward any DNS traffic. The SMF and PGW-C can send to the EASDF new DNS message handling rules (with actual reporting and actions as defined in clause 6.2.3.2.2) when the PDU Session/PDN connection is handed-over (back) to 5GS.

When a PDN connection is initiated in EPS, the SMF and PGW-C can also select a normal DNS Server (i.e. different from an EASDF) to serve the PDN Connection, and then indicate to the UE to use the EASDF as DNS Server when the PDU Session/PDN connection is moved to 5GS.

In some embodiments, in case the UE requested the DNS Server IP address via DHCP after the completion of the handover, the SMF may send a DHCP force renew for or DHCP reconfigure for IPV6 towards the UE via the UPF for each DNS server IP address that had been part of the DHCP messages.

For DHCP IPv6: In step 3 for each relay-reply (reply) of the FIG. 6, the SMF may replace the DNS Server IP addresses in all DHCP replies if the UE moved to 5GS and EASDF has been allocated.

For DHCP IPV4: In step 4 of DHCP ACK of the FIG. 7, the SMF may replace the DNS Server IP addresses if the UE moved to 5GS and EASDF has been allocated.

Alternatively, instead of making use of the DHCP signalling as described above, even for cases where the UE requested DHCP procedure during the PDU session establishment, the SMF/SMF and PGW-C may signal new DNS server IP address (Option C) to the UE.

Thus, some embodiments may ensure that the UE gets the correct DNS server IP address.

Thus, some embodiments may ensure that the UE is updated to receive DHCP force renew and DHCP reconfiguration and to act according to RFC 6644 and RFC 3203 or the UE is impacted to ignore the DNS server IP addresses in the DHCP messages received from the DHCP relay agent located at the SMF.

The SMF may intercept DHCP to retrieve the DNS server IP addresses from the DHCP in order to be able to instruct the EASDF to forward not matching FQDN DNS queries to the DNS server signalled in the DHCP exchange.

The SMF may replace the IP address of the DNS server IP addresses in the DHCP messages.

The EASDF interface may carry DNS resolver address for FQDNs for DNS server signalled in the DHCP messages

The SMF may inject DHCP message as defined in RFC3203 “DHCP reconfiguration” and/or RFC6644 “Rebind Capability in DHCPv6 Reconfigure Messages” towards the UE to trigger to retrieve the actual DNS server IP address.

Refence is made to FIG. 8 which shows a signal flow in a UE requested PDU session establishment.

As referenced 1, the UE sends a NAS message to the AMF to request the establishment of a PDU session. A UE that supports EAS re-discovery may indicate so in the PCO.

As referenced 2, in response to the request, the AMF selects an SMF

As referenced 3, the AMF send a PDU session create context request. This may be a Nsmf_PDUSession_CreateSMContext Request. This may comprise for example, one or more of a SUPI, selected DNN, UE requested DNN, S-NSSAI(s)—single network slice selection assistance information, PDU Session ID, AMF ID, Request Type, User location information, access type, RAT Type, DNN Selection Mode

As referenced 4, if session management subscription data for corresponding SUPI, DNN and S-NSSAI of the HPLMN is not available, then SMF retrieves the session management subscription data from the UDM (unified data management. The UDM may get this information from UDR

As referenced 5, the SMF sends a PDU session create context request response to the AMF. This may be a Nsmf_PDUSession_CreateSMContext Response

As referenced 6, optional secondary authentication/authorization may be performed.

As referenced 7a, optionally the SMF performs PCF selection if a PCF needs to be selected.

As referenced 7b, optionally the SMF performs a SM (session management) policy association establishment procedure to establish an SM policy association with the selected PCF.

As referenced 8, the SMF selects one or more UPFs.

As referenced 9, optionally the SMF may perform an SMF initiated SM policy association modification procedure

As referenced 10a, the SMF sends a session establishment/modification request to the UPF.

As referenced 10b, the UPF acknowledges by sending a session establishment/modification response.

As referenced 11, the SMF sends a message to the AMF. This may be a Namf_Communication_NIN2Message Transfer message. This message may comprise one or more of the PDU Session ID, UE Requested DNN, allocated IPv4 address as well as information that the AMF is to forward to the RAN.

As referenced 12, the AMF sends to the RAN a PDU session request. This is a NAS message which may include PDU Session ID, and a N1 SM container (PDU Session Establishment Accept)).

As referenced 13, the RAN may issue AN specific signalling exchange with the UE that is related with the information received from SMF. The RAN forwards the NAS message (PDU Session ID, N1 SM container (PDU Session Establishment Accept)) provided in step 12 to the UE.

As referenced 14, the RAN provides a PDU session response to the AMF.

The PDU session is thus established.

Some embodiments may allow edge computing to work for DHCP procedure.

In the above described embodiments, reference has been made to DNS IP addresses. It should be appreciated that this is by way of example only and other embodiments may alternatively or additionally used with other IP addresses. For example, the IP addresses may be of one or more of a P-CSCF, a LNS (L2TP (Layer 2 tunnelling protocol) network server) or any other server.

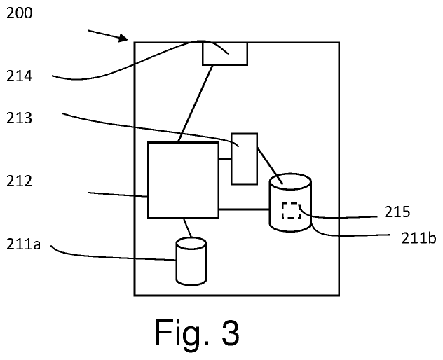

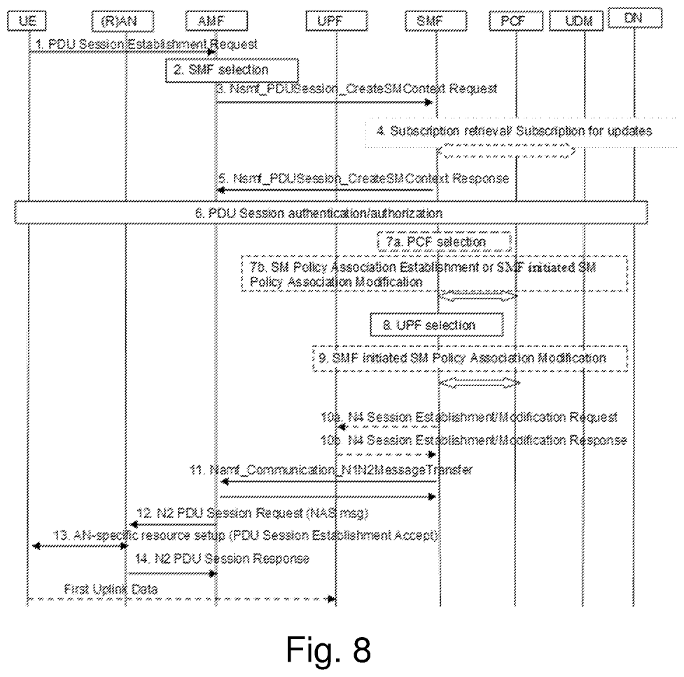

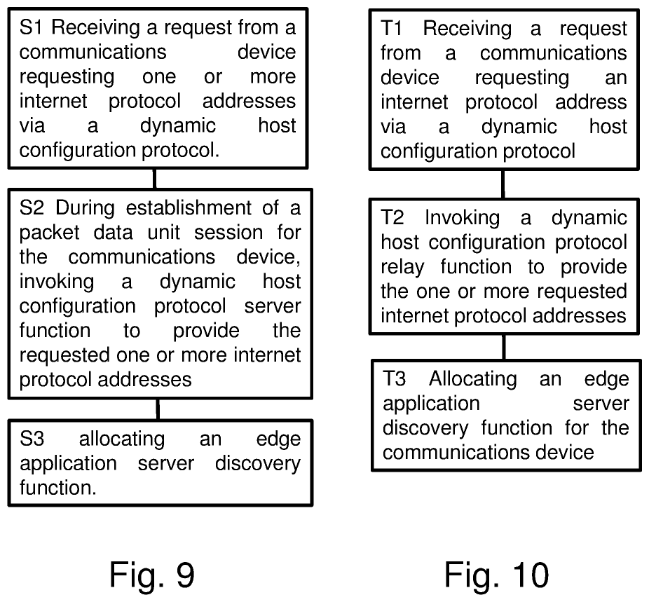

A method of some embodiments will now be described with reference to FIG. 9. The method may be performed by an apparatus. The apparatus may be provided in a session management function or be a session management function. The apparatus may be as shown for example in FIG. 3.

As referenced S1, the method comprises receiving a request from a communications device requesting one or more internet protocol addresses via a dynamic host configuration protocol.

As referenced S2, the method comprises during establishment of a packet data unit session for the communications device, invoking a dynamic host configuration protocol server function to provide the requested one or more internet protocol addresses.

As referenced S3, the method comprises allocating an edge application server discovery function.

A method of some embodiments will now be described with reference to FIG. 10. The method may be performed by an apparatus. The apparatus may be provided in a session management function or be a session management function. The apparatus may be as shown for example in FIG. 3.

As referenced T1, the method comprises receiving a request from a communications device requesting an internet protocol address via a dynamic host configuration protocol.

As referenced T2, the method comprises invoking a dynamic host configuration protocol relay function to provide the one or more requested internet protocol addresses.

As referenced T3, the method comprises allocating an edge application server discovery function for the communications device.

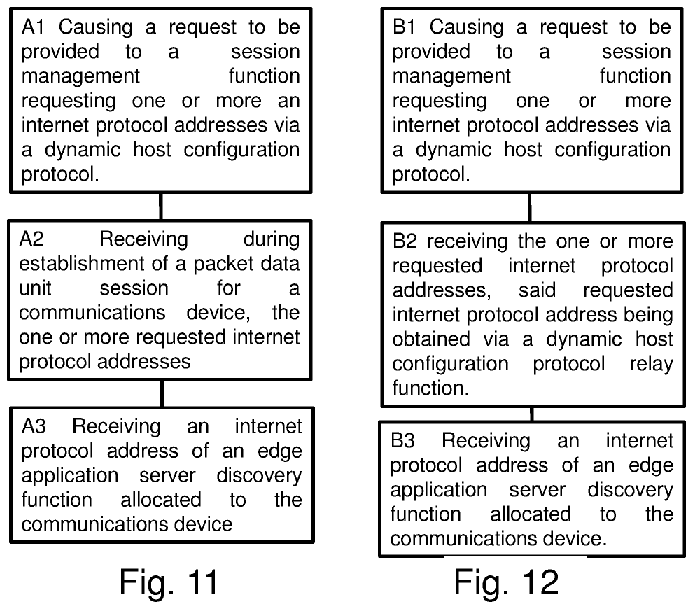

A method of some embodiments will now be described with reference to FIG. 11. The method may be performed by an apparatus. The apparatus may be provided in a communications device or be a communications device. The apparatus may be as shown for example in FIG. 3.

As referenced A1, the method comprises causing a request to be provided to a session management function requesting one or more an internet protocol addresses via a dynamic host configuration protocol.

As referenced A2, the method comprises receiving during establishment of a packet data unit session for a communications device, the one or more requested internet protocol addresses.

As referenced A3, the method comprises receiving an internet protocol address of an edge application server discovery function allocated to the communications device.

A method of some embodiments will now be described with reference to FIG. 12. The method may be performed by an apparatus. The apparatus may be provided in a communications device or be a communications device. The apparatus may be as shown for example in FIG. 3.

As referenced B1, the method comprises causing a request to be provided to a session management function requesting one or more internet protocol addresses via a dynamic host configuration protocol.

As referenced B2, the method comprises receiving the one or more requested internet protocol addresses, said requested internet protocol address being obtained via a dynamic host configuration protocol relay function.

As referenced B3, the method comprises receiving an internet protocol address of an edge application server discovery function allocated to the communications device.

Although the apparatuses have been described as one entity, different modules and memory may be implemented in one or more physical or logical entities.

It is noted that whilst some embodiments have been described in relation to 5G system, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

Some embodiments may be implemented by circuitry. The term “circuitry” may refer to one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions), and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, an integrated circuit or chiplet.

The embodiments of this disclosure may be implemented by computer software executable by a data processor, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks, and functions. The software may be stored on such physical media as memory chips, or memory blocks implemented within the processor, magnetic media such as hard disk or floppy disks, and optical media such as for example DVD and the data variants thereof, CD or any other suitable physical media. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory, and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples. Embodiments of the disclosure may be practiced in various components such as integrated circuit modules.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-30. (canceled)

31. An apparatus comprising:
at least one processor;
at least one memory storing instructions of a session management function, wherein the instructions, when executed by the at least one processor, cause the apparatus to perform operations, the operations comprising at least:
during establishment of a packet data unit session for a communication device:
receiving, from the communications device, a request for allocation, via a dynamic host configuration protocol, an internet protocol address for the communication device;
selecting an edge application server discovery function as a domain name server for the packet data unit session;
invoking dynamic host configuration protocol server functionality and allocating the internet protocol address to the communication device;
sending, to the edge application server discovery function, a request for creation of a context for the edge application discovery function; and
after receipt of a response to the request for creation of the context of the edge application discovery function, sending via the dynamic host configuration protocol, a response to the request for allocation comprising the internet protocol address allocated to the communication device.

32. The apparatus of claim 31, wherein the response to the request for allocation further comprises an address of the edge application server discovery function.

33. The apparatus of claim 31, wherein the operations further comprise receiving a packet data unit establishment request comprising the request for allocation, and wherein the response comprises a packet data unit accept message.

34. The apparatus of claim 31, wherein the request for allocation is provided in a protocol configuration option.

35. The apparatus of claim 31, wherein the context create request comprises a Neasdf_DNSContext_Create Request.

36. The apparatus of claim 35, wherein the Neasdf_DNSContext_Create Request comprises at least one of: the internet protocol address that is allocated to the communication device, a subscription permanent identifier, a data network name, a notification endpoint, and domain name serve message handling rules.

37. The apparatus of claim 31, wherein the selecting of the edge application server discovery function for the communications device is performed after the internet protocol addresses has been allocated to the communication device.

38. The apparatus of claim 31, wherein the operations further comprise providing, to the edge application server discovery function, the internet protocol address allocated to the communication device.

39. The apparatus of claim 31, wherein the operations further comprising:
after establishment of the packet data unit session:
sending, to the edge application server discovery function, a request to update the context for the edge application discovery function; and
receiving, from the edge application server discovery function, an updated context for the edge application discovery function.

40. A method comprising:
during establishment of a packet data unit session for a communication device:
receiving, from the communications device, a request for allocation, via a dynamic host configuration protocol, an internet protocol address for the communication device;
selecting an edge application server discovery function as a domain name server for the packet data unit session;
invoking dynamic host configuration protocol server functionality and allocating the internet protocol address to the communication device;
sending, to the edge application server discovery function, a request for creation of a context for the edge application discovery function; and
after receipt of a response to the request for creation of the context of the edge application discovery function, sending via the dynamic host configuration protocol, a response to the request for allocation comprising the internet protocol address allocated to the communication device.

41. The method of claim 40, wherein the response to the request for allocation further comprises an address of the edge application server discovery function.

42. The method of claim 40, further comprising receiving a packet data unit establishment request comprising the request for allocation, and wherein the response comprises a packet data unit accept message.

43. The method of claim 40, wherein the request for allocation is provided in a protocol configuration option.

44. The method of claim 40, wherein the context create request comprises a Neasdf_DNSContext_Create Request.

45. The apparatus of claim 44, wherein the Neasdf_DNSContext_Create Request comprises at least one of: the internet protocol address allocated to the communication device, a
after receipt of a response to the request for creation of the context of the edge application discovery function, sending via the dynamic host configuration protocol, a response to the request for allocation comprising the internet protocol address allocated to the communication device.

50. The non-transitory computer-readable medium of claim 49, wherein the response to the request for allocation further comprises an address of the edge application server discovery function.
